(19) United States
(12) Patent Application Publication
(10) Pub. No.: US 2017/0228675 A1
(43) Pub. Date: Aug. 10, 2017

(54) EVALUATING A CONTENT ITEM RETENTION PERIOD

(71) Applicant: International Business Machines Corporation, Armonk, NY (US)

(72) Inventors: Roman Kisin, San Jose, CA (US); Deidre Paknad, Palo Alto, CA (US); Andrey Pogodin, San Jose, CA (US); Irina Simpson, Sunnyvale, CA (US)

(21) Appl. No.: 15/040,821

(22) Filed: Feb. 10, 2016

(51) Int. Cl. G06Q 10/06; G06F 17/30

(52) U.S. Cl. CPC G06Q 10/0637; G06Q 10/0635; G06F 17/30303

(57) ABSTRACT

Provided are techniques for evaluating a content item retention period. Quantitative metrics, cost-based metrics, and cost-risk metrics are provided for content items in a content management system. A retention period for each of the content items is determined based on any one of the provided quantitative metrics, cost-based metrics, and cost-risk metrics

### FIELD

Embodiments of the invention relate to evaluating a content item retention period.

### BACKGROUND

As the amount of documents (a type of content) at a business (i.e., an enterprise or company) grows exponentially, so do the content storage and management costs. However, the Information Technology (IT) budget typically does not grow as fast. As a result, businesses implement retention (defensible disposition) programs to delete documents after a certain period, thus saving storage and management costs and, possibly, avoiding or limiting legal risks.

A retention period for a document is defined by legal requirements and business needs. For example, a design of a customer proposal may be stored for 3 years after a contract signature; but business users may want to store the customer proposal for a longer period of time, since they often use old customer proposals as a source of ideas for new proposals.

A typical way to estimate a business-driven retention period is to assess costs and benefits of storing the documents versus deleting the documents, and using this information to identify a retention period (starting with a document creation date) that takes into consideration these costs and benefits that are optimal for the business. However, different clients may use different measures of costs and benefits.

### SUMMARY

Provided is a method for evaluating a content item retention period. The method comprises: providing, with a processor of a computer, quantitative metrics, cost-based metrics, and cost-risk metrics for content items in a content management system; and determining a retention period for each of the content items based on any one of the provided quantitative metrics, cost-based metrics, and cost-risk metrics.

Provided is a computer program product for evaluating a content item retention period. The computer program product comprises a computer readable storage medium having program code embodied therewith, the program code executable by at least one processor to perform: providing quantitative metrics, cost-based metrics, and cost-risk metrics for content items in a content management system; and determining a retention period for each of the content items based on any one of the provided quantitative metrics, cost-based metrics, and cost-risk metrics.

Provided is a computer system for evaluating a content item retention period. The computer system comprise one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform: providing quantitative metrics, cost-based metrics, and cost-risk metrics for content items in a content management system; and determining a retention period for each of the content items based on any one of the provided quantitative metrics, cost-based metrics, and cost-risk metrics.

With embodiments, the quantitative metrics are used to determine the retention period for a content item based on a certain percentage of prematurely disposed content items.

With embodiments, the cost-based metrics are used to determine the retention period for a content item based on a gain in storage cost for a given level of premature disposition.

With embodiments, the cost-risk metrics are used to determine the retention period for a content item based on an estimated average loss for the content item that is prematurely disposed of and a cost of storage for the content item.

With embodiments, marginal risk-related losses are equal to marginal cost-related gains based on the estimated average loss and the cost of storage.

With embodiments, in response to receiving a target value for any retention period, a premature disposition ratio is calculated. Then, in response to receiving a target value for any premature disposition ratio, the retention period is calculated.

With embodiments, the retention period is determined using a risk-time function and a cost-time function.

With embodiments, a Software as a Service (SaaS) is configured to perform the method operations. This advantageously provides a cloud based embodiment.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates, in a flow chart, operations for determining a retention period in accordance with certain embodiments.

FIG. 3 illustrates a computing environment in accordance with certain embodiments.

FIG. 4 illustrates a cloud computing environment in accordance with certain embodiments.

FIG. 5 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments provide a retention tool that uses various assessment methodologies. The retention tool promotes the ideas of defensible disposal for businesses and provides defensible and convincing methodologies for evaluating business-driven retention periods.

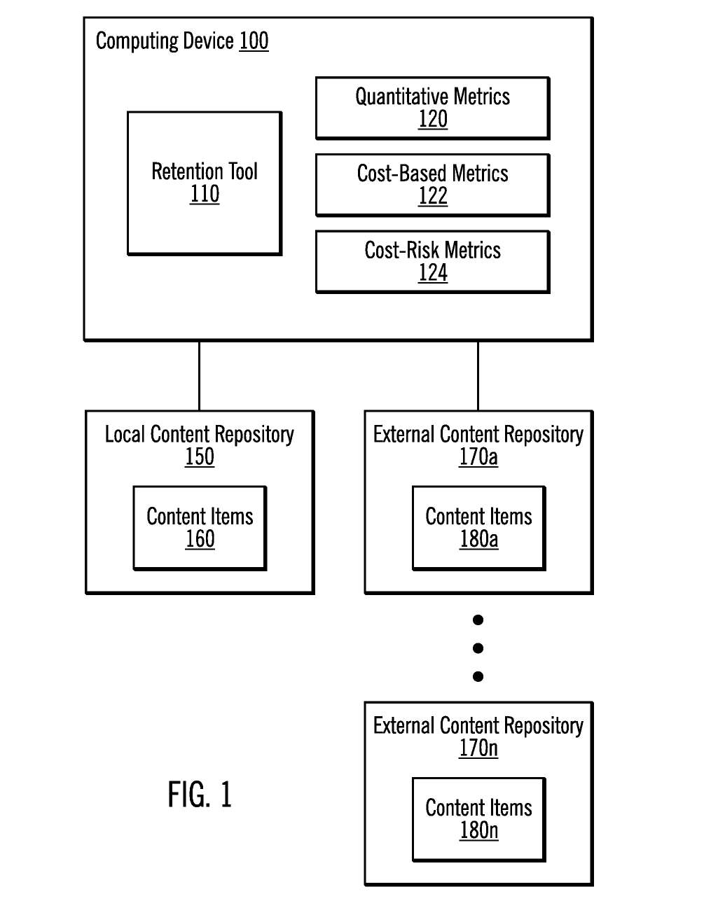

FIG. 1 illustrates, in a block diagram, a computing environment in accordance with certain embodiments. A computing device 100 includes a retention tool 110 and provides quantitative metrics 120, cost-based metrics 122, and cost-risk metrics 124. The computing device 100 is coupled to a local content repository 150 and to one or more external content repositories 170a . . . 170n. The content repository 150 includes content items 160, and each external content repository 170a . . . 170n includes content items 180a . . . 180n. The content items may include documents, web pages, images, etc. The content repositories 150, 170a . . . 170n may be various types of content repositories, which may include, but are not limited to: file systems, enterprise repositories, non-enterprise or external repositories (e.g., belonging to another enterprise), content management systems, file shares, etc. In certain embodiments, the content repositories 150, 170a . . . 170n may be referred to as data sources.

With embodiments, the retention tool 110 connects to the content repositories 150, 170a . . . 170n and analyzes creation and last access dates of content items. Based on this information, the retention tool 110 allows a user to make decisions based on, for example, the quantitative metrics, cost-based metrics, and cost-risk metrics. With embodiments, a “user” may be a human user, a computer program, a device, etc.

With embodiments, quantitative metrics determine what the retention period should be if a user wants a guarantee that no more than a certain percentage of content items will fail to be found because they have been prematurely disposed of. The following notations are possible:
An example of percentage is: “If you want a guarantee that no more than 0.1% percent of documents you are going to open in future are prematurely disposed of, you should delete them no earlier than in 3 years after creation”.
An example of relative numbers is: “If you want a guarantee that no more than 1 document out of 1000 is prematurely disposed of, you should delete them no earlier than in x years after creation”.
An example of absolute numbers is: “If you want a guarantee that no more than 5 documents out of 5234 documents residing on a content repository are prematurely disposed of, you should delete them no earlier than in y years after creation”
An example of reliability is: “.x9”=“If you want 0.999-reliable disposition, you should delete them no earlier than in z years after creation”. Here, x9 refers to downtime, where x may be a number (e.g., 9) after the decimal point. Meaning that 0.9 means that the system is unavailable no longer than 10% of the time, 0.99 means that the system is unavailable no longer than 1% of the time, 0.999 means that the system is unavailable no longer than 0.1% of the time, etc.

With embodiments, cost-based metrics determine what gain in storage cost is achieved for a given level of premature disposition. With such embodiments, the user enters storage cost per the unit of information (e.g., $ per Gigabyte (GB)), and the retention tool 110 takes into account content item sizes and produces output similar to, for example:
“If you choose a retention policy of 3 years, you will need 34.1 GB less storage space, which will result in $12,321 savings. The premature disposition rate will be 0.1%”.

For cost-based metrics, the retention tool 110 may produce two estimates:
One estimate is time savings, such as how much may be saved compared to a “no-disposition” status quo.
Another estimate is on-going savings, such as how much may be saved or lost 1) if a retention period is decreased or increased or 2) if premature disposition requirements are loosened or tightened.

With embodiments, cost-risk metrics determine what the optimal retention period is where marginal risk-related losses are equal to marginal cost-related gains. For this, a user enters an estimated average loss for a prematurely disposed content item and cost of storage per unit of information. Then, the retention tool 110 calculates the retention for which:
if content items are stored for longer, the reduction in risk exposure will not justify extra storage cost.
if content items are deleted earlier, additional savings in storage costs will not justify the increase in risk exposure.

With embodiments, the retention tool 110 may be a stand-alone client application, a web application running on a computer (e.g., a consultant's computer) or a server based application running permanently from a data center.

With embodiments, the retention tool 110 may include one or more repository setup User Interfaces (UIs) and one or more analytical UIs.

The retention tool 110 may utilize crawlers, which crawl repositories and collect necessary retention information. Also, the retention tool 110 may utilize filters, such as an abstraction layer between the retention tool 110 and the repository, which abstracts out the differences in repository access Application Programming Interfaces (APIs).

In certain embodiments, to calculate premature disposition, the retention tool 110 first fills in an array of counters. Each array member in the array of counters represents a number of months between a creation date and a last access date of a content item, and the value of the counter for a particular array member represents a number of content items found that fit into the array member. For example, if the number of months between the creation date and the last access date of a particular content item is “5”, then, the counter for the array member representing 5 months is incremented.

Second, based on this collection, the retention tool 110 draws a histogram with an array index on a horizontal access and counter values on a vertical axis. The retention tool 110 interpolates this into a “Retention Period-Premature Disposition Ratio” (RP) curve (RP-curve) and a reverse RP curve (e.g., a “Premature Disposition Ratio-Retention Period” (PR) curve or “PR-curve”). In certain embodiments the retention tool 110 displays a PR-curve as a PR chart or as a discrete histogram. In certain embodiments “visualization” is used to refer to a chart, a curve or a histogram.

Third, using direct functions, reverse functions, and sliders (data pickers) as input, the retention tool 110 calculates X from Y or vice versa, where X is a retention period value and Y is a premature disposition value. Certain embodiments use continuous functions, which are a result of interpolation. However, other embodiments may be based on discrete functions.

Some embodiments may be tilted towards shorter retention periods because the files created and accessed recently (and that have a high probability to be accessed again) add weight to counters with smaller array indexes. This may be mitigated by introducing a 2-dimensional (2-D) array in which, in addition to month discrepancy, the elements are grouped by calendar month since the inception of the content repository. Based on this data, the retention tool 110 calculates multiple histograms (e.g., from month 0 to month N, from month 0 to month N-1, etc.). Then, the retention tool 110 compares the results. For example, if the discrepancy between the 0-to-N histogram and the 0-to-N-1 histogram is large, the retention tool 110 compares the 0-to-N-1 histogram with the 0-to-N-2 histogram, etc., until the discrepancy becomes insignificant. Then, the retention tool 110 uses the data from 0-to-N-x as a basis of further calculations.

With embodiments, the “insignificant discrepancy” is determined based on a threshold (e.g., a default threshold provided by the retention tool 110 or a threshold set by a user). In certain embodiments, there may be some inherent discrepancy, and, if the threshold is lower than that inherent discrepancy, the retention tool 110 may not be able to choose any set. Therefore, the retention tool 110 and/or a user are able to modify the threshold. With embodiments, there may be multiple ways to calculate the threshold for determining inherent discrepancy.

Also, the nature of a business may change over time, causing a change in retention—last access patterns. Also, content items may be imported initially from another content repository, which may make early behavior atypical. To mitigate this factor, the retention tool 110 is able to move the starting point (e.g., the date the content item was created) to a different date (e.g., a later date or an earlier date). The retention tool 110 also may determine this starting date by comparing multiple samples starting from different dates and deciding on the right starting date when discrepancy is below some threshold.

With embodiments, premature disposition events may have a probabilistic nature. That is, if the retention tool 110 creates charts starting with different dates, this may result in different percentages of content items that have been accessed after these dates. The retention tool 110 takes this into account by:
running multiple calculations starting with different entry points;
building a distribution curve for each point;
choosing a value that safely guarantees the probability of P % where P is a setting; and
taking into account statistical error because the representative sample may not be ideal.

With embodiments, these details go to the footnotes of a report provided by the retention tool 110.

With embodiments, a content repository may be not be old enough to provide a representative sample needed for calculating retention rates with low premature disposition percentages. This may manifest itself in a histogram and sliders that may not allow for these values. If a user still wants to have an estimate, the user may choose to revise the settings and obtain the estimate. With embodiments, the footnotes in the report reflect this.

With embodiments, the retention tool 110 stores and restores default customer settings and provides factory recommended (default) settings. The settings may be determined during installation of the retention tool 110. The default settings may be modified by the retention tool 110 or by a user.

For cost metric calculation, in addition to collecting data for quantitative metric calculation, the retention tool 110 collects data showing the number of content items created each month and an average content item size per month.

First, in cost metric calculation, the retention tool 110 performs premature disposition calculation based on the entire body of data (e.g., the content items).

In certain embodiments, the cost metric calculation is performed based on a current date (e.g., calendar date on which the cost metric calculation is performed) using premature disposition values that have already been measured (either on the current date or before the current date). The user sets the values of the premature disposition ratio or retention period parameter, and the retention tool 110 calculates the retention period or Premature Disposition ratio (whichever was not set by the user) and the earliest date after which the content items should not be deleted.

Then, the retention tool 110 sums up the number of bytes (for the content items) for all previous months to generate a first value and multiplies the first value by cost of storage. This is done starting from month 0 and displaying a running total for each month. This constitutes a Cost-Time (CT) function, which indicates how much storage cost may be saved if a particular policy is applied to the repository right now. This Cost-Time curve allows a user to enter a retention policy and calculate savings. Indirectly, the user can enter a premature disposition ratio, convert this into a retention period using the PR function, and calculate savings using the CT function.

If the user needs to compare the cost consequences of two policies, the retention tool 110 performs the cost metric calculations twice using two parameter sets and displays the delta.

For risk-cost metric calculation, in addition to previously calculated data, the retention tool 110 takes the input from the user on the risk of losing a single content item expressed in dollars. Based on this value, using a PR function and starting from the current date, the retention tool 110 calculates what the risk exposure would be if the user decides to dispose of content items older than L months. Based on that, the retention tool 110 calculates the Risk-Time (RT) function.

Likewise, the retention tool 110 calculates the CT function to determine what the cost savings is if the user decides to dispose of content items older than L months.

Then, the retention tool 110 calculates the derivatives of the RT and CT functions. The latest intersection of these derivatives constitutes an optimal point at which it does not make sense to decrease the retention period any further.

When the user selects premature disposition ratio or retention period targets different from the optimal point, the retention tool 110 calculates the discrepancy or calculates both costs compared to an optimal point, and displays: what the change in storage cost is, what the change in risk is, and what the total cost deviation from the optimal point is. Also the retention tool 110 displays the total savings at the optimal point compared to status-quo.

With embodiments, the retention tool 110 provides UIs for setup, repository overview, and analytical parts.

The retention tool 110 contains a setup form, crawling buttons, and a content item volume growth chart. The content item volume growth chart displays time along the horizontal axis and number of content items or volume in bytes (which may be toggled) along the vertical axis.

The settings UI contains settings. The retention tool 110 provides default settings, which may be applicable in certain embodiments. In other embodiments, the retention tool 110 or the user may change these default settings.

The retention tool 110 includes a repository template and/or ability to create repositories from blank.

The user also may 1) set up cost and risk data, 2) inherit the cost and risk data from a template or 3) obtain defaults from the template and overwrite these.

Embodiments provide an analytical UI. With embodiments, the analytical UI includes a set of screens, one per metric. Embodiments are not limited to the UIs described herein, and it should be apparent to a skilled practitioner that UIs may be structured differently as long as they achieve the same functionality. For example, all the metrics may be calculated on one UI screen or may be located together with the repository overview screen.

The quantitative metric UI includes:
Information describing how long ago the data source has been crawled last (crawling status).
Run button, which triggers metric's calculation process.
Display area containing information on results of crawling, data collection, and calculations.
A result panel that displays either a chart or a table containing “Retention Period-Premature Disposition Ratio” curve (RP-curve) and a mode-switching control.
Sliders (data pickers) allow the user to set either retention or premature disposition target values. Once one of these values is selected, the retention tool 110 calculates the other one of the values for display on the chart.
Decision display area displaying the result of data selection in a verbal form using notations.
Report (e.g., in Portable Data Format (PDF)) export button to allow for export of a summary page containing the information displayed on this quantitative metric UI screen, including the current selection on the RP-curve. While exporting, the user may add comments, which will become hardcoded into the report. The report may be used for the purpose of justifying and documenting the choice of retention period. The report may be in Portable Data Format (PDF) form or some other form.

The cost-based estimate UI includes:
Crawling status information.
Storage cost per unit of information input fields (storage cost text field and unit drop down).
Run button, which triggers metric's calculation process.
Display area containing the information on results of crawling, data collection, and calculation and total storage cost.
A result panel that displays either a chart or a table containing “Cost-Time” curve (CT-curve) and a second chart that contains the Retention Period-Premature Disposition Ratio” curve (RP-curve).
Sliders (data pickers) allow the user to set either retention or non-recall target values. Once one of these values is selected, the retention tool 110 calculates the other one of the values and total savings.
For the purpose of comparing two policies, this cost-based estimate screen may have two data pickers on each dimension: Initial and New. Initial pickers are set up to infinity for retention period and 0 for premature disposition ratio. When the user wants to compare a selected policy against no-policy at all, the user uses the New set of pickers only. If the user wants to compare a new policy against some pre-existing policy, the user may set up the pre-existing policy by using Initial controls.
Decision display area displaying the result of data selection, including cost savings in a verbal form using the notations.
Report export button to allow for export of a summary page containing the information displayed on this cost-based estimate screen. The report may be in Portable Data Format (PDF) form or some other form.

The cost-risk estimate UI includes:
Crawling status information.
Storage cost per unit of information input fields (storage cost text field and unit drop down).
Risk exposure per number of content items input fields.
Run button, which triggers metric's calculation process.
Display area containing the information on results of crawling, data collection, and calculation results and total storage cost.
A result panel that displays either 1) a chart or a table containing “Risk exposure-Storage savings” curve (RS-curve) derived from the CT and RT functions and an optimal point or 2) displaying CT and RT curves or their derivatives.
A second chart containing a PR-curve. Based on results of the run, the first chart displays the optimal point, and the second chart highlights results corresponding to the optimal point.
Sliders (data pickers) allow the user to set either retention or non-recall target values. Once one of these values is selected, the retention tool 110 calculates the other one of the values for display on the chart (while keeping the optimal point for comparison).
Decision display area displaying the result of data selection in a verbal form using the notations. Also the retention tool 110 displays how far away the decision is from an optimal point.
Report export button to allow for export of a summary page containing the information displayed on this screen.

Embodiments determine a net present value that takes into account the time value of money. That is, savings achieved today are more valuable than risks incurred in the future.

Embodiments may consider non-linear storage cost behavior. Storage cost may be a sum of a number of continuous non-linear factors. For example: storage is bought in chunks, and people are hired discretely when the amount of equipment to supervise exceeds a certain threshold.

With certain embodiments, deletions are not taken into account. Some content items are deleted as a part of normal operation. Certain embodiments assume that all the content items are created and stored permanently. Embodiments identify stale areas. For example, the retention tool 110 identifies areas where content items are not used at all. This may be a result of, for example, a user leaving the business or an application being discontinued.

The retention tool 110 identifies partitions in which content items have not been created for longer than P months. The output is the list of such partitions. Then, users may either leave these partitions to the normal retention process, delete them manually, or exclude them from retention calculations (since they are not part of a typical pattern).

The retention tool 110 selects partitions where analysis makes sense. For example, it makes sense to report that “no files have been used for 3 months in a folder \\Filer1\EngTemp\Employee521” because this is a folder of a terminated employee. On the other hand, it does not make sense to report that “no files have been used for 3 months in a folder \\Filer1\EngTemp\Employee801\presentations\patents\0001” since the branch \\Filer1\EngTemp\Employee801 is active and normal retention policies should be applied to this folder.

To achieve that, the retention tool 110 allows for defining parents (e.g., \\Filer1\EngTemp) under which the children (e.g., not all descendants but only children) should be subject to analysis. With embodiments, if there are any files under the child directory or its descendant, the partition is considered active.

Embodiments measure compliance. The retention tool 110 allows estimating how compliant the content repository is with a particular retention policy. The user enters the required retention period, and the retention tool 110 provides numeric and financial discrepancies between status-quo and the required policy.

With embodiments, the retention tool 110 provides compliance reports per repository.

Embodiments provide enterprise-wide compliance. The retention tool 110 provides aggregate reports on compliance, where multiple content repositories are included. Such a report measures an average deviation in retention period, storage cost, and risk compared to the target. The targets may be optimal points or intermediate realistic values (e.g., set by project managers overseeing implementation of defensible disposal).

Embodiments provide customers for a way to understand the impact of choosing a given disposition/retention policy. Embodiments may reveal approximate one time and on-going cost savings and risk metrics, such as: what is the probability of, or percentage of, content items that will fail to be found because they have been prematurely disposed of? This risk may be expressed in “9's” notation or percentages that are familiar to customers. Embodiments also provide optimization of these tradeoffs, expressed as cost-risk metrics.

Embodiments provide a tool to assist content owners in determining defensible retention policies where they could save money and still retain the appropriate amount of content items for their business needs.

Embodiments enable analyzing the value of content items (e.g., business value) and allow the user to define policies based on their preferred trade-offs and metrics.

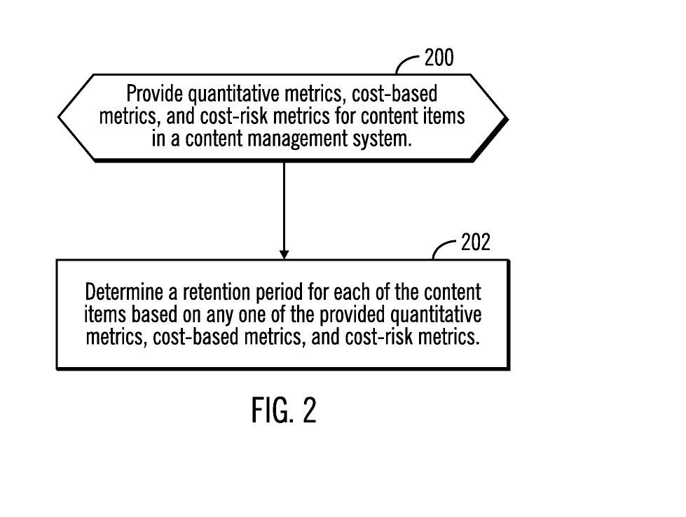

FIG. 2 illustrates, in a flow chart, operations for determining a retention period in accordance with certain embodiments. Control begins at block 200 with the retention tool 110 providing quantitative metrics, cost-based metrics, and cost-risk metrics for content items in a content management system. In certain embodiments, providing includes retrieving the quantitative metrics, cost-based metrics, and cost-risk metrics from storage (e.g., memory, remote storage, local storage, etc.). In block 202, the retention tool 110 determines a retention period for each of the content items based on any one of the provided quantitative metrics, cost-based metrics, and cost-risk metrics.

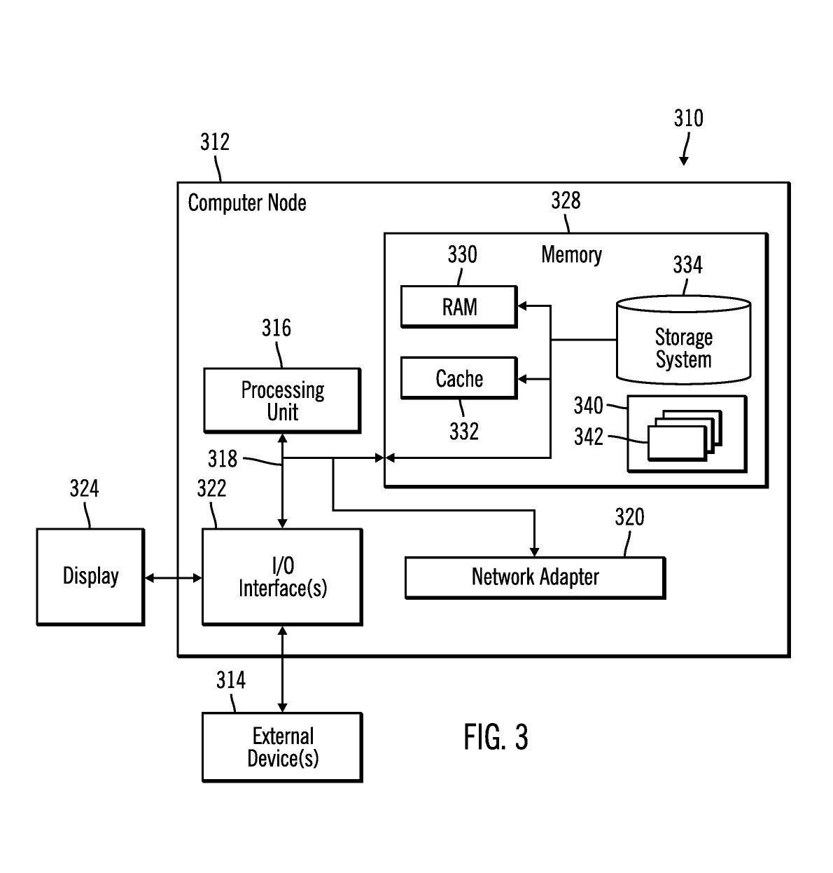

FIG. 3 illustrates a computing environment 310 in accordance with certain embodiments. In certain embodiments, the computing environment is a cloud computing environment. Referring to FIG. 3, computer node 312 is only one example of a suitable computing node and is not intended to suggest any limitation as to the scope of use or functionality of embodiments of the invention described herein. Regardless, computer node 312 is capable of being implemented and/or performing any of the functionality set forth hereinabove.

The computer node 312 may be a computer system, which is operational with numerous other general purpose or special purpose computing system environments or configurations. Examples of well-known computing systems, environments, and/or configurations that may be suitable for use with computer node 312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer node 312 may be described in the general context of computer system executable instructions, such as program modules, being executed by a computer system. Generally, program modules may include routines, programs, objects, components, logic, data structures, and so on that perform particular tasks or implement particular abstract data types. Computer node 312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer node 312 in cloud computing node 310 is shown in the form of a general-purpose computing device. The components of computer node 312 may include, but are not limited to, one or more processors or processing units 316, a system memory 328, and a bus 318 that couples various system components including system memory 328 to processor 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer node 312 typically includes a variety of computer system readable media. Such media may be any available media that is accessible by computer node 312, and it includes both volatile and non-volatile media, removable and non-removable media.

System memory 328 can include computer system readable media in the form of volatile memory, such as random access memory (RAM) 330 and/or cache memory 332. Computer node 312 may further include other removable/non-removable, volatile/non-volatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 may include at least one program product having a set (e.g., at least one) of program modules that are configured to carry out the functions of embodiments of the invention.

Program/utility 340, having a set (at least one) of program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments of the invention as described herein.

Computer node 312 may also communicate with one or more external devices 314 such as a keyboard, a pointing device, a display 324, etc.; one or more devices that enable a user to interact with computer node 312; and/or any devices (e.g., network card, modem, etc.) that enable computer node 312 to communicate with one or more other computing devices. Such communication can occur via Input/Output (I/O) interfaces 322. Still yet, computer node 312 can communicate with one or more networks such as a local area network (LAN), a general wide area network (WAN), and/or a public network (e.g., the Internet) via network adapter 320. As depicted, network adapter 320 communicates with the other components of computer node 312 via bus 318. It should be understood that although not shown, other hardware and/or software components could be used in conjunction with computer node 312. Examples, include, but are not limited to: microcode, device drivers, redundant processing units, external disk drive arrays, RAID systems, tape drives, and data archival storage systems, etc.

In certain embodiments, the computing device 100 has the architecture of computer node 312. In certain embodiments, the computing device 100 is part of a cloud environment. In certain alternative embodiments, the computing device 100 is not part of a cloud environment.

### Cloud Embodiments

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

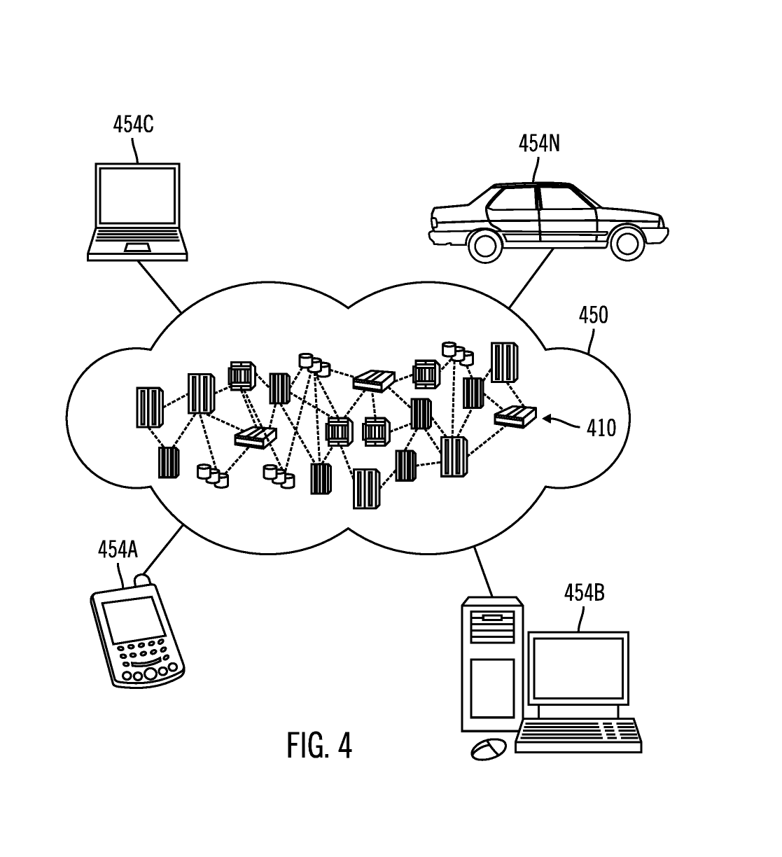

Referring now to FIG. 4, illustrative cloud computing environment 450 is depicted. As shown, cloud computing environment 450 comprises one or more cloud computing nodes 410 with which local computing devices used by cloud consumers, such as, for example, personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 410 and cloud computing environment 450 can communicate with any type of computerized device over any type of network and/or network addressable connection (e.g., using a web browser).

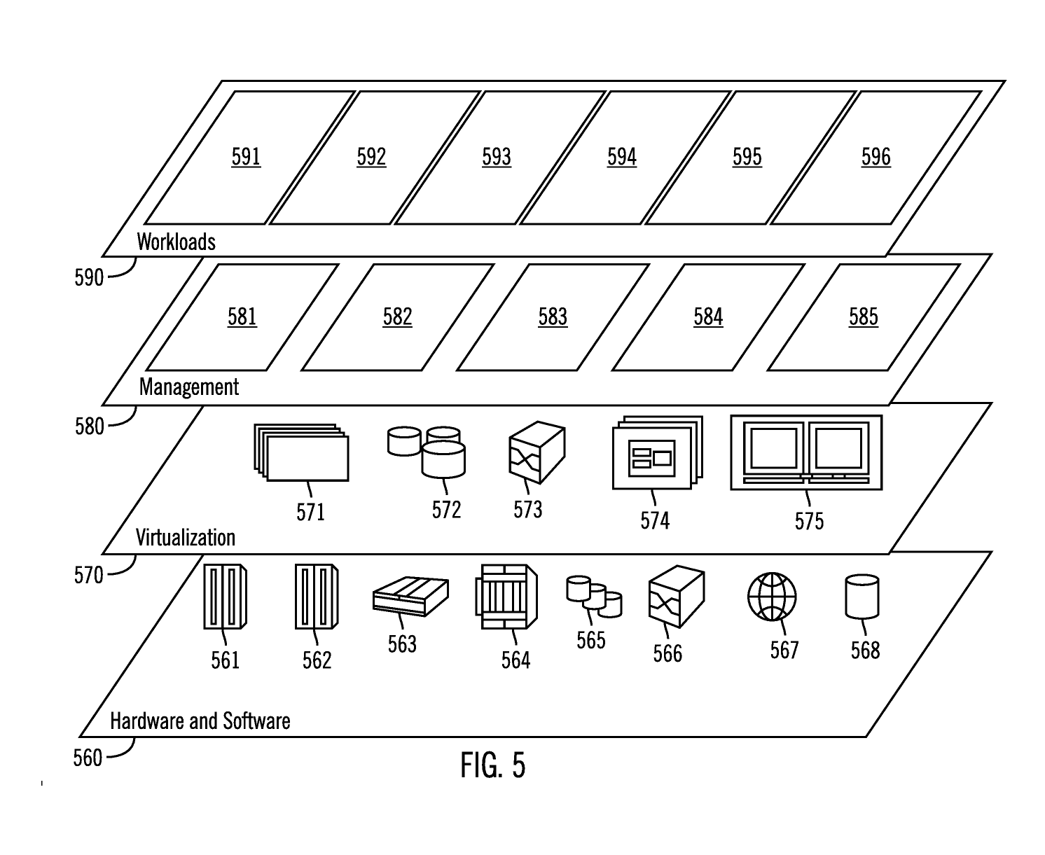

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and retention period determination 596.

Thus, in certain embodiments, software or a program, implementing retention period determination in accordance with embodiments described herein, is provided as a service in a cloud environment.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, comprising:
providing, with a processor of a computer, quantitative metrics and cost-based metrics for content items in a content management system;
determining a retention period for each of the content items based on any one of the provided quantitative metrics and cost-based metrics and in accordance with a number of the content items that are prematurely disposed; and
retaining each of the content items for the determined retention period.

2. The method of claim 1, wherein the quantitative metrics are used to determine the retention period for a content item based on a certain percentage of prematurely disposed content items.

3. The method of claim 1, wherein the cost-based metrics are used to determine the retention period for a content item based on a gain in storage cost for a given level of premature disposition.

4. The method of claim 1, further comprising:
determining a retention period for each of the content items based on cost-risk metrics, wherein the cost-risk metrics are used to determine the retention period for a content item based on an estimated average loss for the content item that is prematurely disposed of and a cost of storage for the content item.

5. The method of claim 4, wherein marginal risk-related losses are equal to marginal cost-related gains based on the estimated average loss and the cost of storage.

6. The method of claim 1, further comprising:
in response to receiving a target value for any retention period, calculating a premature disposition ratio; and
in response to receiving a target value for any premature disposition ratio, calculating the retention period.

7. The method of claim 1, wherein the retention period is determined using a risk-time function and a cost-time function.

8. The method of claim 1, wherein a Software as a Service (SaaS) is configured to perform the method operations.

9. A computer program product, the computer program product comprising a computer readable storage medium having program code embodied therewith, the program code executable by at least one processor to perform:
providing quantitative metrics and cost-based metrics for content items in a content management system;
determining a retention period for each of the content items based on any one of the provided quantitative metrics and cost-based metrics and in accordance with a number of the content items that are prematurely disposed; and
retaining each of the content items for the determined retention period.

10. The computer program product of claim 9, wherein the quantitative metrics are used to determine the retention period for a content item based on a certain percentage of prematurely disposed content items.

11. The computer program product of claim 9, wherein the cost-based metrics are used to determine the retention period for a content item based on a gain in storage cost for a given level of premature disposition.

12. The computer program product of claim 9, wherein the program code is executable by at least one processor to perform:
determining a retention period for each of the content items based on cost-risk metrics, wherein the cost-risk metrics are used to determine the retention period for a content item based on an estimated average loss for the content item that is prematurely disposed of and a cost of storage for the content item.

13. The computer program product of claim 12, wherein marginal risk-related losses are equal to marginal cost-related gains based on the estimated average loss and the cost of storage.

14. The computer program product of claim 9, wherein the program code is executable by at least one processor to perform:
in response to receiving a target value for any retention period, calculating a premature disposition ratio; and
in response to receiving a target value for any premature disposition ratio, calculating the retention period.

15. The computer program product of claim 9, wherein the retention period is determined using a risk-time function and a cost-time function.

16. The computer program product of claim 9, wherein a Software as a Service (SaaS) is configured to perform the computer program product operations.

17. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to perform:
providing quantitative metrics and cost-based metrics for content items in a content management system;
determining a retention period for each of the content items based on any one of the provided quantitative metrics and cost-based metrics and in accordance with a number of the content items that are prematurely disposed; and
retaining each of the content items for the determined retention period.

18. The computer system of claim 17, wherein the quantitative metrics are used to determine the retention period for a content item based on a certain percentage of prematurely disposed content items.

19. The computer system of claim 17, wherein the cost-based metrics are used to determine the retention period for a content item based on a gain in storage cost for a given level of premature disposition.

20. The computer system of claim 17, wherein the program instructions perform:
determining a retention period for each of the content items based on cost-risk metrics, wherein the cost-risk metrics are used to determine the retention period for a content item based on an estimated average loss for the content item that is prematurely disposed of and a cost of storage for the content item.

21. The computer system of claim 20, wherein marginal risk-related losses are equal to marginal cost-related gains based on the estimated average loss and the cost of storage.

22. The computer system of claim 17, wherein the program instructions perform:
in response to receiving a target value for any retention period, calculating a premature disposition ratio; and
in response to receiving a target value for any premature disposition ratio, calculating the retention period.

23. The computer system of claim 17, wherein the retention period is determined using a risk-time function and a cost-time function.

24. The computer system of claim 17, wherein a Software as a Service (SaaS) is configured to perform the system operations.
